(19) United States
(12) Patent Application Publication
(10) Pub. No.: US 2012/0186721 A1
(43) Pub. Date: Jul. 26, 2012

(54) FOAMED INSERTS

(75) Inventor: Bruno Preghenella, Gertwiller (FR)

(73) Assignee: Zephyros Inc., Romeo, MI (US)

(21) Appl. No.: 13/387,192

(22) PCT Filed: Aug. 19, 2010
(86) PCT No.: PCT/IB2010/002051

§ 371 Date: Apr. 4, 2012

(30) Foreign Application Priority Data
Jul. 28, 2009 (GB) 0913068.3

(51) Int. Cl. B32B 37/06; B32B 3/26; B32B 3/10

(52) U.S. Cl. 156/79; 428/138; 428/137

(57) ABSTRACT

Foamable material is mounted in a first cavity defining component by providing the foamable material on a foil and by the provision of retaining means in the cavity defining component and matching attachment means in the foil so that the foil/foamable material laminar structure is retained in place and the cavity is formed with a second cavity defining component and the foamable material then foamed to produce a foam filled cavity.

The present invention relates to laminates of foil and foamable material and their use in the provision of foamed inserts and in particular to the provision of foamed inserts in the cavities of vehicles such as automobiles, trucks, busses, railroad vehicles and aircraft.

It is known to provide foamed inserts in the cavities of vehicles for a variety of reasons. The foam may provide light weight reinforcement in vehicles such as in the rails or pillars of automobiles. In this instance the foam tends to be a rigid foam with a relatively low degree of expansion. Cross-linked epoxy based foams are examples of such rigid foams. Foams may also be used to provide sound insulation, vibration damping or sealing in which case a softer higher expansion foam such as one based on thermoplastic materials may be employed.

It is also known and employed that a foamable material may be provided in a vehicle cavity in an unfoamed state and the foamable materials may be such that it will foam under conditions to which the cavity containing the foamable material is subjected during processing of the cavity such as in vehicle assembly processes. One particular technique is to employ a foamable formulation that will foam under the conditions employed in the anticorrosion coating bake oven (sometimes known as e-coat oven) or a paint bake oven. It is also known that the foamable materials may be provided on a carrier which may be rigid and can provide additional reinforcement when the foam is a rigid structural material, a carrier can also be used to provide support for a more flexible foam such as that used for acoustic insulation or vibration damping.

Various means have been proposed for locating the foamable material within a cavity. For example a clip may be provided on the foamable material or as part of a carrier for the foamable material and a hole may be provided in the wall of the cavity through which the clip may pass to secure the foamable material in place. Other proposals include shaping the foamable material on a support for the material so that it is provided with protrusions which will lean against the interior walls of the cavity to hold the foamable material in place by friction. This however requires the foamable material to be close to the wall of the cavity and does not allow for high expansion of the foamable material in all directions. An additional proposal includes providing magnetic material expansion let alone high within the foamable material so it may be secured to the metal wall of the cavity. This also suffers from the disadvantage that the foamable material is in contact with the wall of the cavity in certain areas and the foamable material cannot expand uniformly. Furthermore if the cavity is part of a vehicle frame or seat frame or back which is to be subjected to anticorrosion coating (e coat) after installation of the foamable material it may not be possible to coat the surface of the cavity that is in contact with the foamable material. It has also been proposed that a strip of foamable material may be stuck to one or more surfaces of the cavity by means of an adhesive. Here again it is not possible to perform an effective anticorrosion coating operation in the area where the foamable material is adhering to the metal.

Additional problems associated with these techniques are that complex moulding techniques have been required to produce the foamable material of the desired size and shape for the particular cavity under consideration. There remains a need to provide simpler technology to produce standard or similar components that can be used to fill a variety of cavities with high expansion foam particularly foam providing acoustic insulation. Furthermore additional techniques are required to provide the means of attachment either by moulding an integral attachment to the carrier or the foamable material or the need to secure the fastening means to the carrier or the foamable material. In addition if the attachment is achieved by the passage of a clip through a hole in a metal wall in a cavity the need for the hole may provide a location for corrosion and rusting to occur.

The invention therefore provides a laminar structure comprising a foil carrying a foamable material and provided with one or more holes whereby the foil is adapted to enable it to be attached within the cavity of a vehicle by engagement of the holes with locators provided within the cavity.

The locators within the cavity are preferably matching protrusions matching the holes formed in the foil which can mate with the holes in the foil to secure the laminar structure within the cavity. The protrusions to secure the laminar structure within the cavity may be provided in any suitable manner. For example they may be suitable shaped studs that can be welded or otherwise attached to the inner surface of one or both of the cavity forming members. Alternatively they may be formed during the production of the cavity forming member by providing one or more elements extending from the cavity forming member during the stamping process employed in the creation of the cavity forming member. Alternatively the projections may be provided on a moulded part that may be attached to the cavity forming member such as by means of a clip.

In this way the laminar structure is held in place by the friction between the protrusions and the foil and no additional adhesive is required. In addition the foil also performs the function of guiding the foamable material as it softens and foams during the foaming process. The foil therefore provides shape retention to the foam as well as imparting some rigidity and/or flexibility. If no foil is present the foamable material may sag into the cavity as it softens to enable foaming particularly when a high expansion material is used to provide a more soft foam such as that which provides acoustic insulation.

In a particularly preferred embodiment the means for engagement comprise two or more holes formed in the foil which are shaped to be a tight fit onto corresponding protrusions to secure the laminar structure within the cavity. The holes may also pass through the foamable material or the foamable material may be attached to the foil in a manner that leaves the holes exposed.

The present invention therefore provides inserts which enable a simple and reliable technique for the provision of foamable material within a cavity and allows a more standard and simplified manufacturing process to be used. The invention is also concerned with the foaming of the material to provide a foam structure within the cavity. Cavities in vehicles such as rails and pillars or in vehicle seats, frames or backs are frequently formed by the bonding together of two suitably shaped cavity defining members which may be bonded together by welding in the case where they are of metal such as steel alternatively they may be stuck together by an adhesive such as a structural adhesive. At least one of the cavity defining members is typically U shaped or C shaped and is provided with plates at the extremity of the shape which provide an area for bonding to another cavity defining member which may be planar or also a U or C shaped member so that the U or C shape or shapes defines the cavity and the plates provide areas where the two members may be bonded together.

According to the present invention protrusions are provided on one or both of the cavity defining members and the foil carrying the foamable material is provided with holes so that it can be fixed to the protrusions.

In a further embodiment the invention provides a process for providing a foam within a cavity comprising providing a first cavity forming member with retaining means on the cavity defining surface, fixing a foil carrying a foamable material on the retaining means, attaching a second cavity forming member to the first cavity forming member and causing the foamable material to foam.

The cavity forming members may be metal stampings from metals such as steel and aluminium and the retaining means may be one or more protrusions formed during the stamping process, alternatively the protrusions may be provided by studs welded onto the cavity forming member. In a preferred embodiment the retaining means are protrusions and are provided centrally in the cavity defining portion of the member so that the foil carrying the foamable material can be installed centrally to enable uniform foaming. In a further preferred embodiment two retaining means are provided and the foil bridges the two retaining means so that it and is held in place by the two retaining means.

The laminar structure is designed so that the foil can be applied to and retained by the retaining means and in the preferred embodiment where two retaining means are provided the foil may be longer than the distance between the two retaining means and the foil may be designed to engage with the retaining means. For example the retaining means may be two pins or studs and holes may be formed in the foil at positions corresponding to the pins or studs so that the foil may be pushed onto the pins or studs so they protrude into and perhaps through the foil to hold it in the desired position. In this embodiment the holes are preferably sized to be a tight fit on the pins so that no additional adhesive is required to hold the foil in place. In a preferred embodiment the surface of the pins or studs is roughened of bevelled to increase the grip on the circumference of the hole or holes formed in the foil.

The foamable material may be attached to one or both sides of the foil and it may be provided with holes aligned with the holes in the foil so that the retaining means passes through both the foil and the foamable material. Alternatively the foamable material may be attached to the foil in a manner that leaves the holes in the foil exposed for receipt of the retaining means. In a further embodiment two foils may be attached to both sides of a strip of the foamable material.

The foil may be of a metal, such as aluminium or steel foil such as shimstock; alternatively a plastic foil such as a polyester such as polyethylene terphthalate, polyamide or polyolefine foils may be used. The optimum thickness of the foil will depend upon the material from which it is made, the required length of the foil, the distance between the securing holes and the amount of foamable material if is required to carry. However we have found that foils of a thickness in the range of 0.005 mm to 1.5 mm are particularly useful more preferably of a thickness 0.075 to 1 mm. The use of the foil helps to secure the foamable material within the cavity and improves the handle ability of the material as well as aiding in the foaming operation.

The foamable material may cover all or part of one or both surfaces of the foil, in a preferred embodiment a layer of foamable material is provided on both sides of an aluminium foil. Conveniently the laminar structures may be obtained by the extrusion of the foamable material at a temperature below that at which it foams onto the foil and cutting the extrudate to the required size and stamping the laminate to provide locations such as holes for engagement with the retaining means in the cavity forming member. For example the foamable material may be extruded onto one or both sides of a moving foil, conveniently obtained from a reel, the foamable material is then allowed to solidify and the laminate cut to produce the required size and shape of laminar structure which may then be stamped or cut to provide the retaining holes.

While the preferred embodiment has been described in relation to the provision of two retaining means in the cavity forming section of one of the cavity forming members the invention is equally applicable to larger or smaller cavities and the number of retaining means and corresponding holes in the foil and optionally the foamable material may be tailored to suit the size and shape of the cavity. Furthermore retaining means may be provided in both cavity forming members.

In a further embodiment of the invention where the cavity containing structures are provided and the application of the foil/foamable laminar material is to be accomplished on an assembly line the laminar structure material may be provided with means to enable it to be handled and applied by a robot. In such a process the first cavity forming member provided with the retaining means may be delivered to a station where the laminar structure is engaged with the retaining means, the second cavity forming member which may be any shape also provided with plates, for example it may be planar or a matching image may then be applied on to the plates of the first cavity forming member where it is secured to provide the cavity containing the laminar structure mounted in the desired position within the cavity. The cavity structure containing the laminar structure may then pass for further assembly and treatment and the foamable material may be formulated so that it foams during the subsequent treatment such as by exposure to the heat employed during the baking of anticorrosion and/or paint layers that are applied during manufacture and assembly of the article containing the foamed insert.

The foamable material will be selected according to the properties the foam is required to impart to the cavity. The invention is particularly useful when the foam is required to provide sealing and/or sound absorption in which case a high expansion, typically 100%-2500% preferably 400-2500% foamable material may be used to produce a soft foam. Alternatively the foam may be required to reduce vibration and/or hardness in the vehicle and/or it may be required to provide crash resistance. If the foam is to provide a reinforcing effect it may be a rigid foam provided from a foamable material with a relatively low degree of expansion, typically 30% to 200% and it may also be a material that cross-links at a similar temperature to that at which it foams. A cross-linkable epoxy resin based formulation may be used. Preferred foamable materials are formulations that are thermoplastic at temperatures below that at which they foam and, accordingly can be extruded or injection moulded to provide the foamable material of the laminar structure at temperatures below the foaming temperature. Upon heating to cause foaming the material may also cross-link if a rigid reinforcing foam is required. The foamable material preferably includes a tackifier such as a petroleum resin or a rosin ester to aid the adhesion of the foamable material to the foil and to aid the adhesion of the foam to the walls of the cavity.

The invention is particularly useful in the provision of sound insulation within automobile cavities when the foamable material is required to provide sound insulation and/or sealing the material may have a degree of expansion such as from 200% to 2500%. It may also be a soft foam without cross linking.

In the preferred production of acoustic baffles for automobiles the foamable material is such as to produce a highly expanded soft foam typically from polymers such as ethylene unsaturated ester copolymers typically ethylene vinyl acetate copolymers and/or ethylene acrylate copolymers. In this embodiment a particularly preferred material is an olefinic polymer-based acoustic foam, and more particularly an ethylene based polymer. For example, the foamable material may be based on an ethylene copolymer or terpolymer that may contain a C₃ to C₈ alpha-olefin comonomer. Examples of particularly preferred polymers include ethylene vinyl acetate copolymers, ethylene acrylate copolymers, EPDM, or mixtures thereof. Other examples of preferred foam formulations that are commercially available include polymer-based materials commercially available from L & L Products, Europe, under the designations as L-2704, L-2806, L-2811, L-2820, L-2821, L-1066, L-2105, L-2106, L-2115, L-2308, L-2411, L-2412, L-2663, L-2664, L-2700, L-2703, L-4161, L-4200, L-4300, L-4315, L-4316, L7102, L7107 and L7220. These materials may readily be laminated to a foil such as aluminium, steel or plastic foil by extrusion to form the laminar structure employed in this invention.

A number of other suitable materials are known in the art and may also be used for producing foams for noise attenuation and/or vibration damping. One such foam includes an open-cell polymeric base material, such as an ethylene-based polymer which, when compounded with appropriate ingredients (typically a blowing and curing agent), expands and cures in a reliable and predictable manner upon the application of heat or the occurrence of a particular ambient condition. From a chemical standpoint for a thermally activated material, an acoustic foam is usually initially processed as a flowable thermoplastic material before curing. It will preferably cross-link upon curing, which makes the material resistant to further flow or change of final shape.

While the preferred materials for fabricating a sound absorption and/or vibration damping material have been disclosed, the material can be formed of other materials (e.g., foams regarded in the art as structural foams) provided that the material selected is heat-activated or otherwise activated by an ambient condition (e.g. moisture, pressure, time or the like) and cures in a predictable and reliable manner under appropriate conditions for the selected application.

Some other possible materials include, but are not limited to, polyolefin materials, copolymers and terpolymers, phenol/formaldehyde materials, phenoxy materials, and polyurethanes. U.S. Pat. Nos. 5,266,133; 5,766,719; 5,755,486; 5,575,526; 5,932,680; and WO 00/27920 describe suitable materials. In general, the desired characteristics of the resulting foam include relatively low glass transition point, and good corrosion resistance properties. In this manner, the material does not generally interfere with the materials systems employed by automobile manufacturers. Moreover, it will withstand the processing conditions typically encountered in the manufacture of a vehicle, such as the e-coat priming, cleaning and degreasing and other coating processes.

Generally, suitable expandable foams have a range of expansion ranging from approximately 100 to over 1000 percent. The level of expansion of the acoustical foam may be to as high as 1500 to 2000 percent or more.

In another embodiment, the sound absorption material may be provided in an encapsulated or partially encapsulated form, for instance an expandable foamable material is encapsulated or partially encapsulated in an adhesive shell. Moreover, the sound absorption material may include a melt-flowable material such as that disclosed in U.S. Pat. No. 6,030,701.

One or more curing agents may be included in the foamable material used in this invention. Optionally curing agent accelerators may also be included. The amounts of curing agents and curing agent accelerators used can vary widely depending upon the type of structure desired, the desired properties of the foamed material and the desired amount of expansion of the foamable material and the desired rate of expansion. Exemplary ranges for the curing agents or curing agent accelerators present in the foamable material range from about 0.001% by weight to about 7% by weight.

Preferably, the curing agents assist the foamable material in curing by cross linking of the polymers, phenoxy epoxy resins or both and any epoxy resin that may be present. It is also preferable for the curing agents to assist in thermosetting the foamed material. Useful classes of curing agents are materials selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. If an accelerator for the curing agent is used examples of materials includes a modified or unmodified urea such as methylene diphenyl bis urea, an imidazole or a combination thereof.

Depending upon the function required of the foamed material, it may include one or more additional polymers or copolymers, which can include a variety of different polymers, such as thermoplastics, elastomers, plastomers and combinations thereof. For example, and without limitation, polymers that might be appropriately incorporated into the foamable material include halogenated polymers, polycarbonates, polyketones, polyurethanes, polyesters, and polymers derived from silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, polyethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

When used, these polymers can comprise a small portion or a more substantial portion of the material. When used, the one or more additional polymers preferably comprises about 0.1% to about 50%, more preferably about 1% to about 20% and even more preferably about 2% to about 10% by weight of the foamable material.

Examples of suitable rigid materials include foamable epoxy-base resins and examples of such materials are the products L0507, L5207, L5214, L5234, L5235, L5236, L5244, L-8050 and L-8150, which are commercially available from L & L Europe, Strasbourg, France. The product should be chosen so that it can be shaped at temperatures below that at which it will foam, typically 80° C. to 90° C. and according to the rate of expansion and foam densities required. It is further preferred that where it is used in automobile frame or seat manufacture it expands at the temperatures experienced in the oven used to dry and cure the anticorrosion coating deposited in the e-coat process, typically 120° C. to 180° C., more typically 130° C. to 150° C. Prior to activation, the foamable material is preferably dry and not tacky to the touch, since this facilitates shipping and handling and prevents contamination.

Epoxy resin is used herein to mean any of the conventional dimeric, oligomeric or polymeric epoxy materials containing at least one epoxy functional group. The epoxy content is typically more than 40%. Moreover, the term epoxy resin can be used to denote one epoxy resin or a combination of multiple epoxy resins. The polymer-based materials may be epoxy-containing materials having one or more oxirane rings polymerizable by a ring opening reaction. In a preferred embodiment, the foamable material includes between about 2% and 75% by weight epoxy resin, more preferably between about 4% and 60% by weight epoxy resin and even more preferably between about 25% and 50% by weight epoxy resin. Of course, amounts of epoxy resin may be greater or lower depending upon the intended application of the activatable material.

The epoxy may be aliphatic, cycloaliphatic, aromatic or the like. The epoxy may be supplied as a solid (e.g., as pellets, chunks, pieces or the like) or a liquid (e.g., an epoxy resin) although liquid resins are preferred to enhance process ability of the adhesive formulation. As used herein, unless otherwise stated, a resin is a solid resin if it is solid at a temperature of 23° C. and is a liquid resin if it is a liquid at 23° C. The epoxy may include an ethylene copolymer or terpolymer.

An epoxy resin may be added to the foamable material to increase the adhesion, flow properties or both of the material. One exemplary epoxy resin may be a phenolic resin, which may be a novolac type or other type resin. Other preferred epoxy containing materials may include a bisphenol-A epichlorohydrin ether polymer, or a bisphenol-A epoxy resin which may be modified with butadiene or another polymeric additive or bisphenol-F-type epoxy resins. Moreover, various mixtures of several different epoxy resins may be employed as well. Examples of suitable epoxy resins are sold under the tradename Araldite GY 282, GY 281 and GY 285 supplied by Huntsman.

In certain embodiments, it may be desirable to include one or more thermoplastic polyethers and/or thermoplastic epoxy resins in the foamable material. When included, the one or more thermoplastic polyethers preferably comprise between about 1% and about 90% by weight of the foamable material, more preferably between about 3% and about 60% by weight of the foamable material and even more preferably between about 4% and about 25% by weight of the foamable material. As with the other materials, however, more or less thermoplastic polyether may be employed depending upon the intended use of the foamable material.

The thermoplastic polyethers typically include pendant hydroxyl moieties. The thermoplastic polyethers may also include aromatic ether/amine repeating units in their backbones. The thermoplastic polyethers of the present invention preferably have a melt index between about 5 and about 100, more preferably between about 25 and about 75 and even more preferably between about 40 and about 60 grams per 10 minutes for samples weighing 2.16 Kg at a temperature of about 190° C. Of course, the thermoplastic polyethers may have higher or lower melt indices depending upon their intended application. Preferred thermoplastic polyethers include, without limitation, polyetheramines, poly(amino ethers), copolymers of monoethanolamine and diglycidyl ether, combinations thereof or the like. Preferably, the thermoplastic polyethers are formed by reacting an amine with an average functionality of 2 or less (e.g., a difunctional amine) with a glycidyl ether (e.g., a diglycidyl ether). As used herein, the term difunctional amine refers to an amine with an average of two reactive groups (e.g., reactive hydrogens).

According to one embodiment, the thermoplastic polyether is formed by reacting a primary amine, a bis(secondary) diamine, a cyclic diamine, a combination thereof or the like (e.g., monoethanolamine) with a diglycidyl ether or by reacting an amine with an epoxy-functionalized poly(alkylene oxide) to form a poly(amino ether). According to another embodiment, the thermoplastic polyether is prepared by reacting a difunctional amine with a diglycidyl ether or diepoxy-functionalized poly (alkylene oxide) under conditions sufficient to cause the amine moieties to react with the epoxy moieties to form a polymer backbone having amine linkages, ether linkages and pendant hydroxyl moieties. Optionally, the polymer may be treated with a monofunctional nucleophile which may or may not be a primary or secondary amine.

Additionally, it is contemplated that amines (e.g., cyclic amines) with one reactive group (e.g., one reactive hydrogen) may be employed for forming the thermoplastic polyether. Advantageously, such amines may assist in controlling the molecular weight of the thermoplastic ether formed.

Examples of preferred thermoplastic polyethers and their methods of formation are disclosed in U.S. Pat. Nos. 5,275,853; 5,464,924 and 5,962,093. Advantageously, the thermoplastic polyethers can provide the foamable material with various desirable characteristics such as desirable physical and chemical properties for a wide variety of applications as is further described herein.

Although not required, the formulation may include one or more ethylene polymers or copolymers such as ethylene acrylate, copolymers and ethylene acetate copolymers. Ethylene methacrylate and ethylene vinyl acetate are two preferred ethylene copolymers.

It may also be desirable to include a reactive polyethylene resin that is modified with one or more reactive groups such as glycidyl methacrylate or maleic anhydride. Examples of such polyethylene resins are sold under the tradename LOTADER® (e.g., LOTADER AX 8900) and are commercially available from Arkema Group.

One or more blowing agents may used to cause the material to be foamable by producing inert gasses that form, as desired, an open and/or closed cellular structure of the foamed material.

The blowing agent may include one or more nitrogen containing groups such as amides, amines and the like. Examples of suitable blowing agents include azodicarbonamide, dinitrosopentamethylenetetramine, azodicarbonamide, initrosopentamethylenetetramine, 4,4ᵢ-oxy-bis-(benzenesulphonylhydrazide), trihydrazinotriazine and N,Nᵢdimethyl-N,Nᵢ-dinitrosoterephthalamide. An accelerator for the blowing agents may also be provided. Various accelerators may be used to increase the rate at which the blowing agents form inert gasses. One preferred blowing agent accelerator is a metal salt, such as an oxide, for example zinc oxide. Other preferred accelerators include modified and unmodified thiazoles or imidazoles. The amounts of blowing agents and blowing agent accelerators that should be used can vary widely depending upon the type of cellular structure desired, the desired amount of expansion the desired rate of expansion and the like. Exemplary ranges for the amounts of blowing agents and blowing agent accelerators in the activatable material range from about 0.001% by weight to about 5% by weight.

The foamable material may also include one or more fillers, including but not limited to particulate materials (e.g., powder), beads, microspheres such as Zeospheres available from Zeelan Industries, or the like. Preferably the filler includes a material that is generally non-reactive with the other components present in the activatable material. While the fillers may generally be present to take up space at a relatively low weight, it is contemplated that the fillers may also impart properties such as strength and impact resistance.

Examples of fillers that may be used include silica, diatomaceous earth, glass, clay (e.g., including nanoclay), talc, pigments, colorants, glass beads or bubbles, glass, carbon or ceramic fibers, nylon or polyamide fibers (e.g., Kevlar), antioxidants, and the like. Such fillers, particularly clays, can assist in levelling itself during flow of the foamable material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers.

When employed, the fillers can range from 10% or less to 90% or greater by weight of the foamable material, but more typical from about 20 to 55% by weight of the foamable material. According to some embodiments, the foamable material may include from about 0% to about 3% by weight, and more preferably slightly less that 1% by weight clays or similar fillers. Powdered (e.g. about 0.01 to about 50, and more preferably about 1 to 25 micron mean particle diameter) mineral type filler can comprise between about 5% and 70% by weight, more preferably about 10% to about 50% by weight.

Other additives, agents or performance modifiers may be included in the foamable material as desired, including but not limited to an antioxidant, a UV resistant agent, a flame retardant, an impact modifier, a heat stabilizer, a colorant, a processing aid, a lubricant, a reinforcement (e.g., chopped or continuous glass, ceramic, aramid, or carbon fibre, particulates or the like). Liquid polysufides may be used to improve the environmental exposure such as exposure to humidity and salt water.

In a preferred embodiment the foamable material contains an adhesion promoting material such as a petroleum resin or a synthetic or naturally occurring rosin ester tackifier. The use of these materials can improve the adhesion of the foamable material to the foil and can also improve the adhesion of the foamed material to the walls of the cavity. It is preferred to include from 0.5 to 10 wt % of such an adhesion promoting material.

When determining appropriate components for the foamable material, it may be important to formulate the material so that it will foam at appropriate times or temperatures. For instance, in some applications, it is undesirable for the material to be reactive at room temperature or otherwise at the ambient temperature in a production environment. More typically, the material flows and foams at higher processing temperatures. As an example, temperatures such as those encountered in an automobile assembly plant may be appropriate, especially when the foamable material is processed along with the other components at elevated temperatures or at higher applied energy levels, e.g., during painting preparation steps.

The amount of foamable material employed will be determined by the size of the cavity in which the foam is to be provided and the desired degree of expansion. However for most vehicles a laminar structure containing a larger foamable material from 1.5 mm to 10 mm thick has been found to be appropriate particularly for the production of a sound absorption and/or vibration damping foam.

The present invention may be used in cavities in body frames and in seats for the structural reinforcement of hollow sections in automobiles or other transportation systems such as trucks, buses, railroad vehicles and aircraft. Here the foamable material is generally a rigid reinforcing thermosetting layer such as a foamable epoxy resin or a foamable polyurethane which may be a blocked polyurethane. In this instance the foamable material serves two main functions, it will expand across the space between the foil and the interior of the hollow section and will bond to some or all of the interior walls of the hollow section. Activation therefore enables the foamable material to expand and fill a gap between the foil and a hollow structure it is designed to reinforce and to bond to selected internal surfaces of the hollow structure. Accordingly the foamable material must expand at the desired temperature and be sufficiently adhesive to firmly bond the reinforcing member inside the vehicle structure. In this embodiment once foamed it should be sufficiently strong that it does not contribute any weakness to the overall reinforcing effect provided.

The invention is illustrated but in no way limited by reference to the accompanying drawings in which:

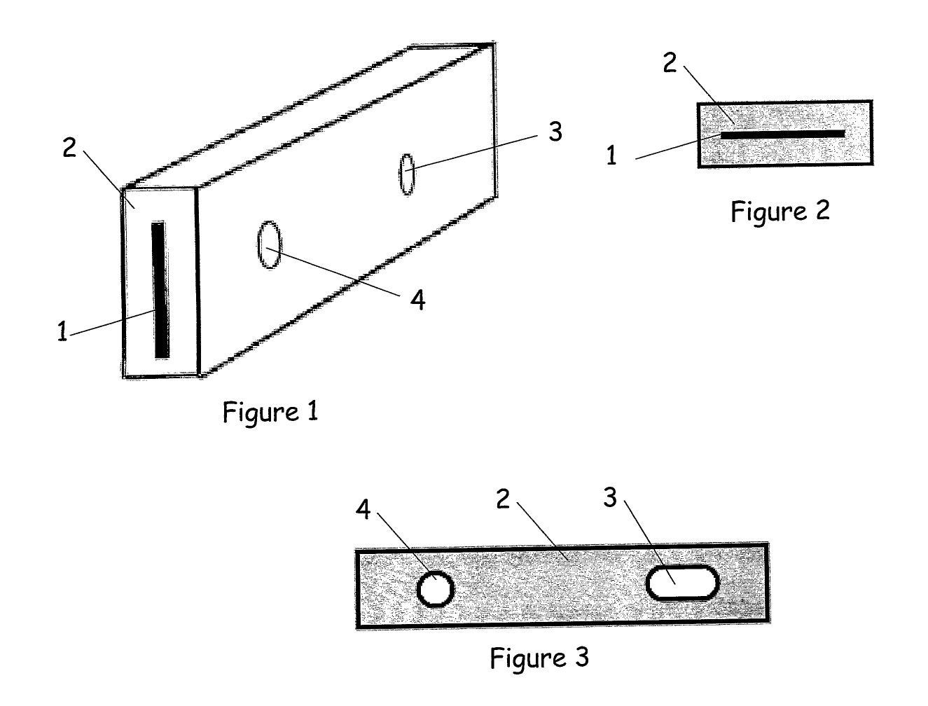

FIG. 1 is a perspective view of a laminar structure of the invention.

FIG. 2 is an end view of the structure shown in FIG. 1.

FIG. 3 is a top view of the structure shown in FIG. 1.

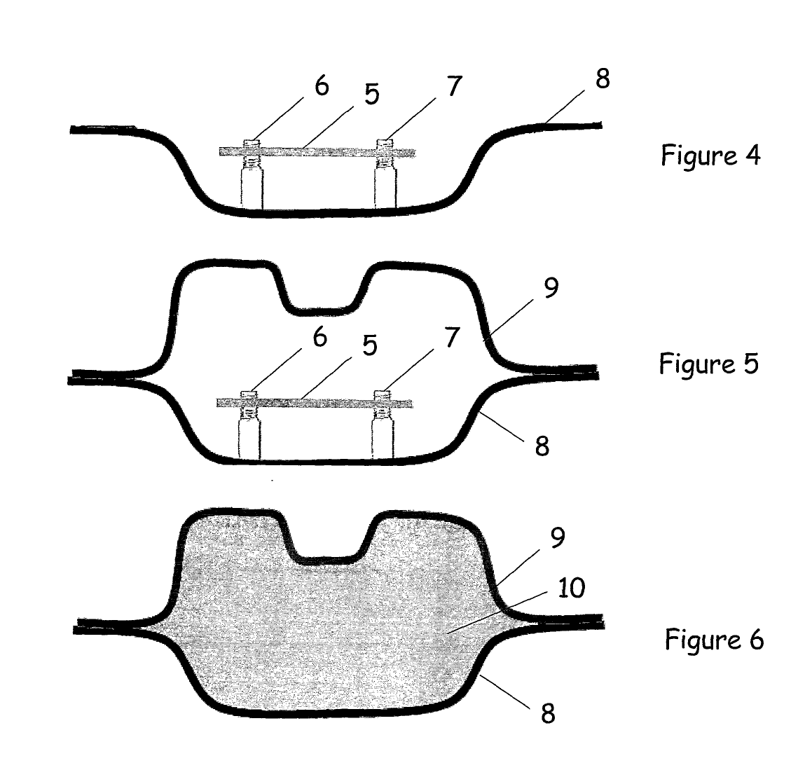

FIG. 4 shows a first cavity defining metal stamping provided with a laminar structure of the invention.

FIG. 5 shows the cavity shown in FIG. 4 completed by the presence of a second cavity defining metal stamping.

FIG. 6 shows the cavity filled with foam produced by the foaming of the foamable material.

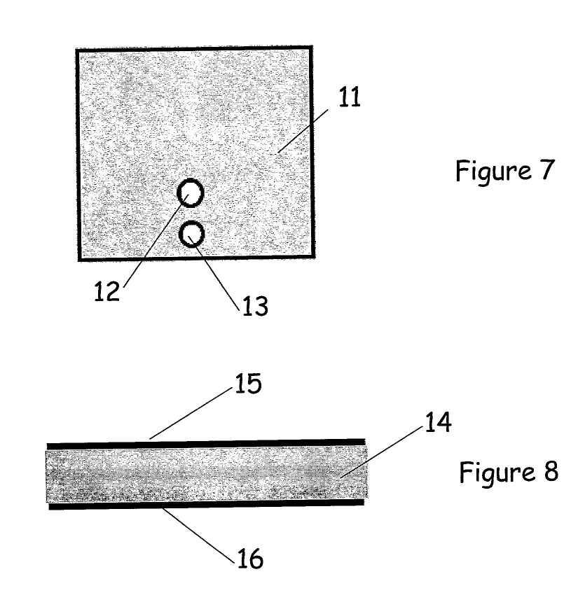

FIG. 7 shows a laminar structure of a different shape.

FIG. 8 is a cross sectioned view of the structure shown in FIG. 7.

FIG. 9 shows different shapes of protrusions that may be provided in a cavity defining member to receive the laminar structure.

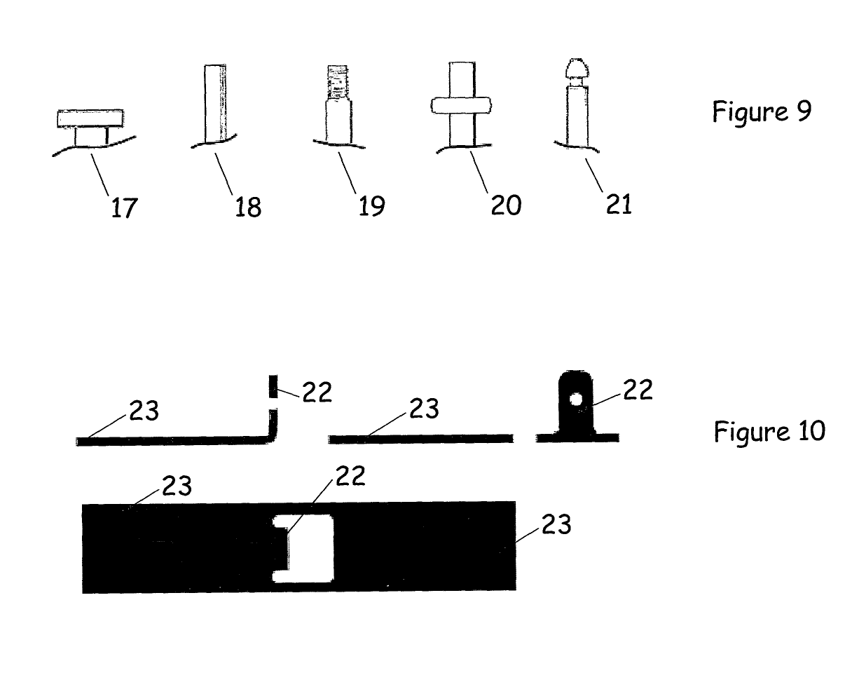

FIG. 10 shows an alternate form of protrusion that may be formed during the production of the cavity defining member.

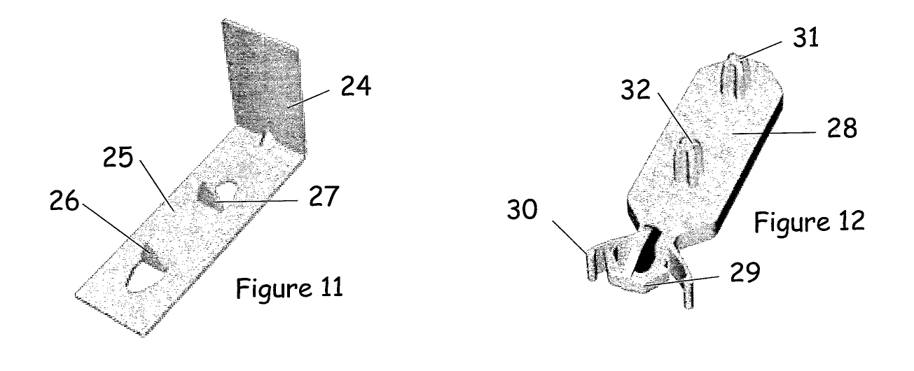

FIG. 11 shows a bracket provided with protrusions that may be attached to the inner surface of the cavity defining member.

FIG. 12 shows a clip with integrally moulded protrusions.

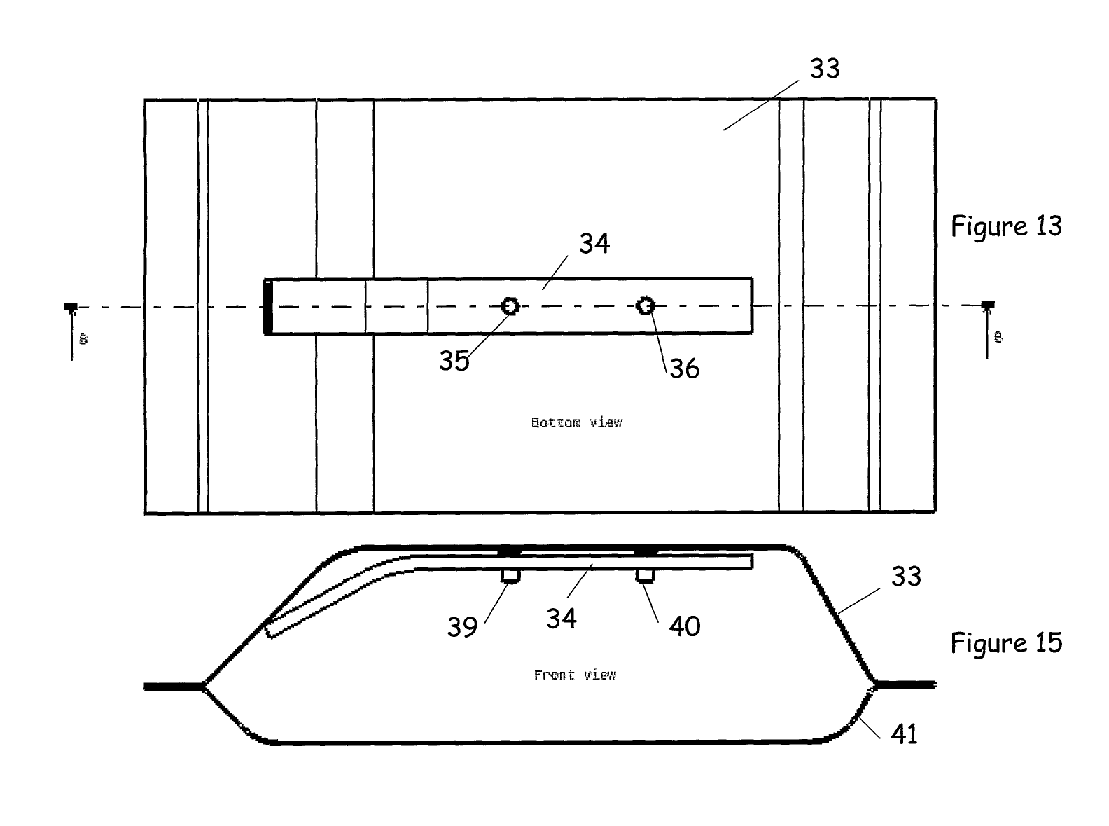

FIG. 13 shows a laminar structure of the invention placed with a cavity defining member.

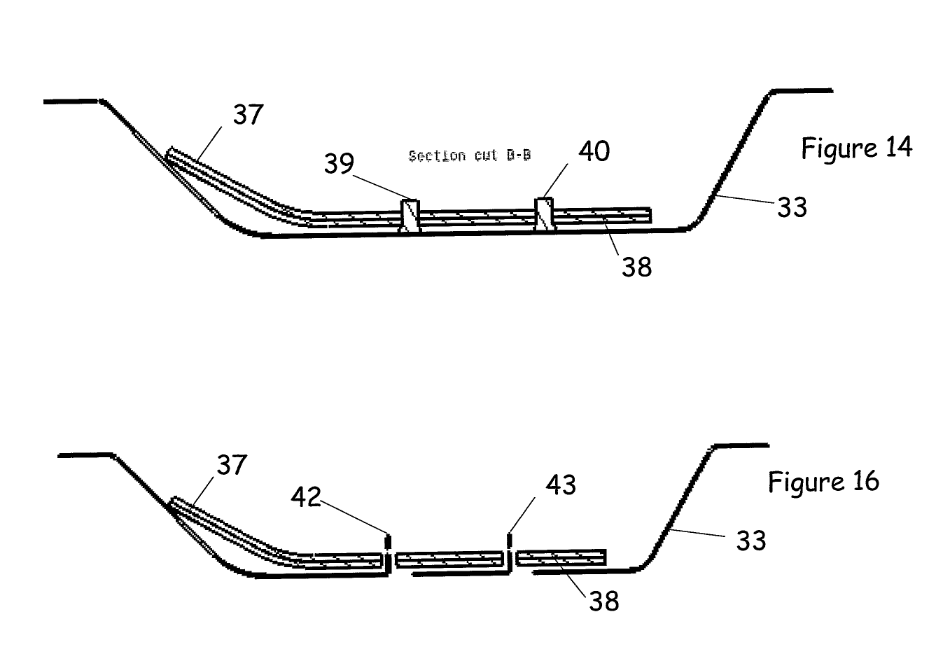

FIG. 14 is a section through B-B of FIG. 13.

FIG. 15 is a front view of the cavity containing the laminar structure shown in FIG. 13.

FIG. 16 shows an alternate method for mounting a laminar structure on a cavity foaming member.

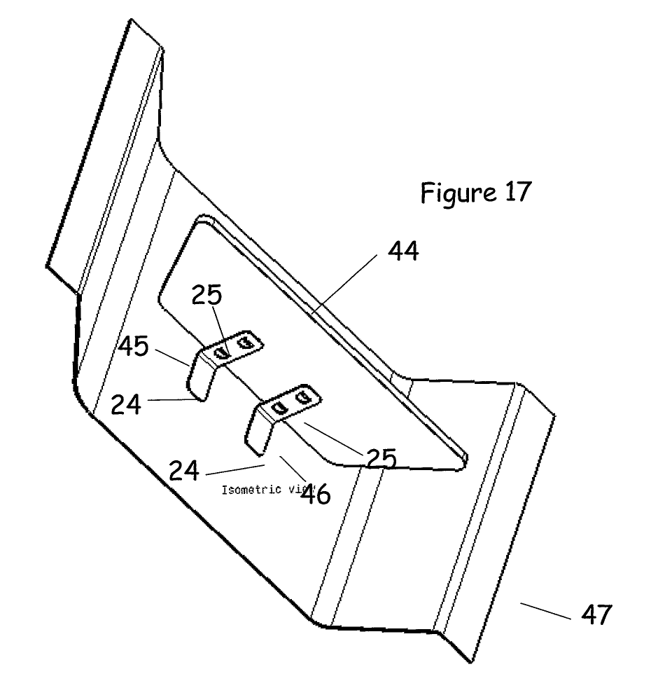

FIG. 17 shows a different shaped laminar structure attached to a cavity forming member.

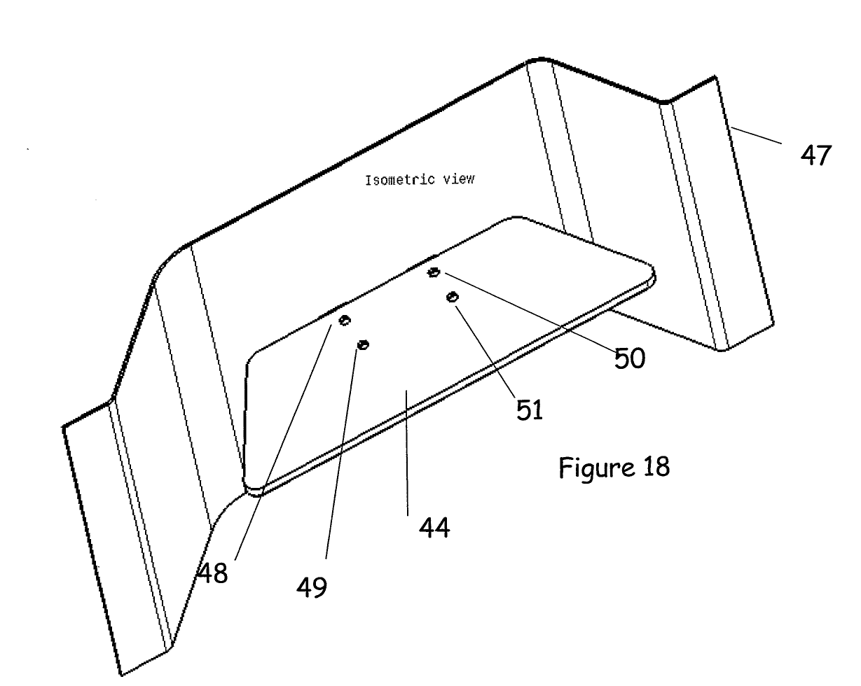

FIG. 18 is an isometric view of the construction shown if FIG. 17.

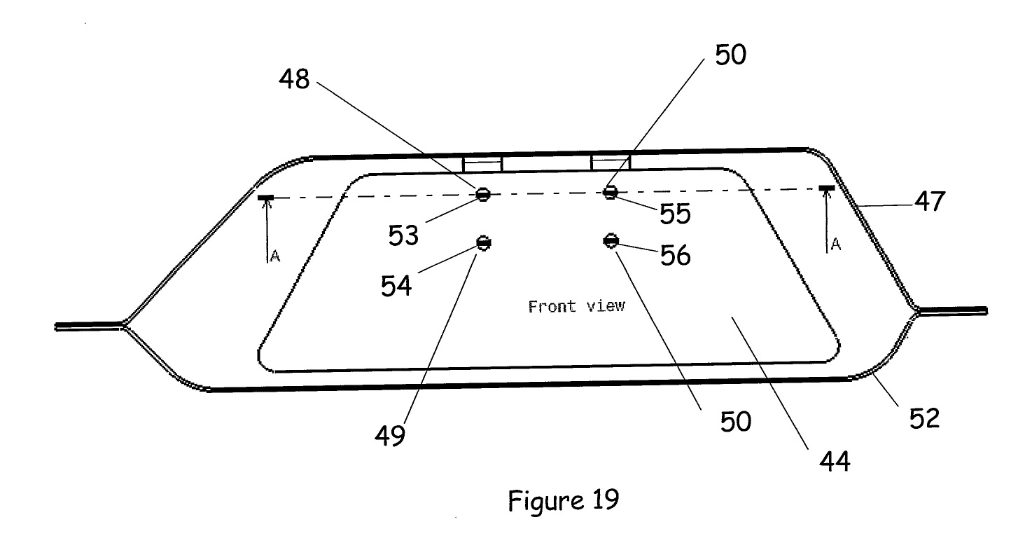

FIG. 19 is the front view of the construction of FIG. 18 with the cavity completed.

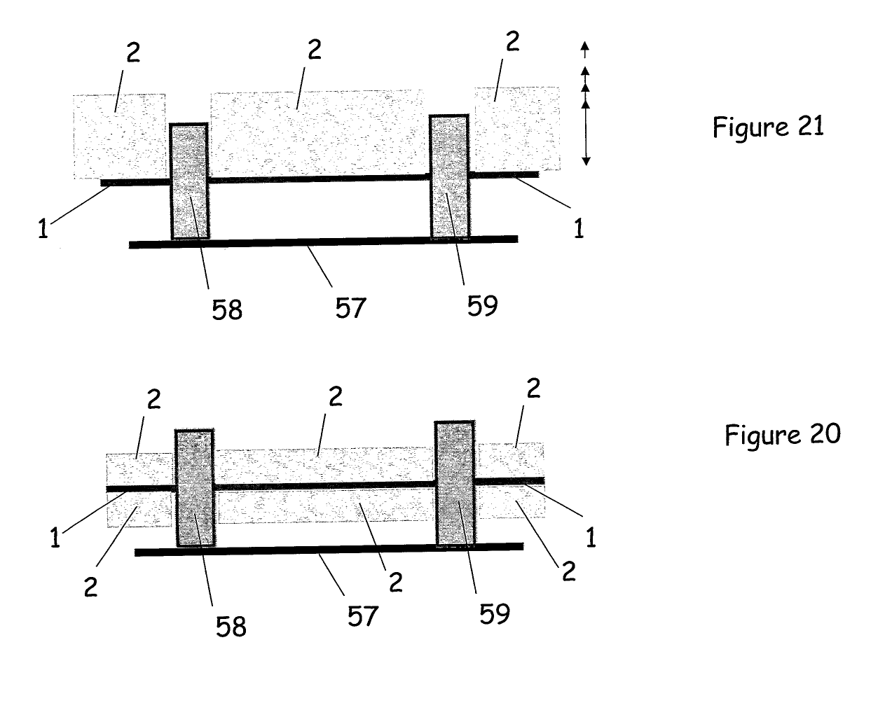

FIG. 20 shows a laminar structure with foamable material on both sides of the foil.

FIG. 21 shows a laminar structure with foamable material on one side of the foil.

FIG. 1 shows a laminar structure of the invention comprising a foil (1) surrounded by foamable material (2) and provided with holes (3) and (4) passing through the structure to enable the structure to be attached to protrusions provided in a cavity defining member. FIG. 2 is an end view of the structure of FIG. 1 and FIG. 3 is a top view of the structure.

FIG. 4 shows a laminar structure (5) such as that shown in FIG. 1 attached to protrusions (6) and (7) formed in a cavity forming member (8). The laminar structure is held in place due to the friction between the protrusions (6) and (7) and the foil (1) (not shown in FIG. 4) of the laminar structure. FIG. 5 shows the cavity being completed by the second cavity forming member (9) and FIG. 6 shows the cavity filled with foam (10) due to the expansion of the foamable material (2) of the laminar structure (5).

FIG. 7 is a top view of an alternate form of laminar structure (11) provided with holes (12) and (13) for attachment to protrusions provided in a cavity. FIG. 8 is a cross sectional view of the structure shown in FIG. 7 with the foamable material (14) between two foils (15) and (16).

FIG. 9 shows five different shapes of protrusions (17), (18), (19), (20) and (21) that may be provided in the cavity forming member for retention of the laminar structure. The protrusion may be welded to the cavity forming member or may be formed during the member stamping formation.

FIG. 10 shows how a protrusion (22) may be formed by breaking and bending the metal during the production of a cavity forming member (23). FIG. 11 shows a bracket comprising a limb (24) that can be welded to the cavity forming member and a limb (25) in which two protrusions (26) and (27) are formed for attachment to the laminar structure of the invention.

FIG. 12 shows a moulded clip (28) provided with arms (29) and (30) which can pass through a hole in a cavity forming member and also provided with protrusions (31) and (32) for receipt of a laminar structure of the invention. The embodiments shown in FIGS. 11 and 12 may be used to retain the laminar structure shown in FIG. 7 by locating the holes (12) and (13) over the protrusions (26) and (27) or (31) and (32).

FIG. 13 is the bottom view of the cavity forming member (33) containing a laminar structure (34) of the present invention provided with holes (35) and (36) for retention by protrusions in the cavity forming member (not shown if FIG. 13).

FIG. 14 is a section view through B-B of FIG. 13 showing the foil (37) and the foamable material (38) of the laminar structure (34) and also showing the protrusions (39) and (40) formed in the cavity forming member for retention of the laminar structure (34).

FIG. 15 is a front view of the cavity formed by providing a second cavity forming member (41) to the first cavity forming member shown in FIG. 13.

FIG. 16 shows how a laminar structure similar to structure (34) may be attached to protrusions (42) and (43) that are integral with the cavity forming (33) member and formed during its stamping.

FIG. 17 is an underside view of a laminar structure (44) similar to that shown in FIG. 7 except the foil is provided with four retaining holes. The foil is attached to two brackets (45) and (46) such as shown in FIG. 11, the protrusions (26) and (27) are not shown as they are within the laminar structure. The brackets are welded to the cavity forming member (47).

FIG. 18 is a topside view of the structure shown in FIG. 17 showing the four holes (48), (49), (50) and (51) into which the two protrusions from each bracket fit.

FIG. 19 is a front view of the construction shown in FIG. 18 with the cavity has been completed by the addition of the second cavity forming member (52) and showing the heads of the protrusions from the brackets (53), (54), (55) and (56).

FIG. 20 shows how a laminar structure such as that shown in FIG. 1 can be held in place within a cavity forming member (52) provided that the foil (1) is a tight fit around the protrusions (58) and (59). FIG. 21 is similar to FIG. 20 showing that the foamable material (2) may be attached to only one side of the foil (1) and that it is not essential that the foamable material (2) contact the protrusions (58) and (59) providing there is a sufficiently tight fit between the foil (1) and the protrusions.

1. A laminar structure comprising a foil carrying a foamable material and provided with one or more holes whereby the foil is adapted to enable it to be attached within a cavity of a vehicle by engagement of the holes with locators provided within the cavity.

2. A laminar structure according to claim 1 comprising two or more holes formed in the foil.

3. A foil laminar structure according to claim 1 wherein the holes pass through the foamable material.

4. A laminar structure according to claim 1 in which the foamable material is attached to both sides of the foil.

5. A laminar structure according to claim 1 in which the foil is of a metal, such as aluminium or steel foil such as shimstock; or a plastic such as a polyester such as polyethylene terphthalate, polyamide or polyolefine.

6. A laminar structure according to claim 1 wherein the foil is of a thickness in the range of from 0.005 mm to 1.5 mm.

7. A laminar structure according to claim 1 wherein the foamable material has an expansion capability of from 100% to 3000%.

8. A laminar structure according to claim 1 in which the foamable material contains an adhesion promoting resin.

9. A laminar structure according to claim 1 wherein the structure provides sound insulation within automobile cavities.

10. A process for providing a foam within a cavity comprising providing a first cavity forming member with retaining means on the cavity defining surface, fixing a foil carrying a foamable material on the retaining means, attaching a second cavity forming member to the first cavity forming member and causing the foamable material to foam.

11. A process according to claim 10 in which the retaining means comprise one or more protrusions formed during the manufacture of the first cavity forming member.

12. A process according to claim 10 wherein the protrusions are studs welded onto the cavity forming member.

13. A process according to claim 10 wherein two retaining means are provided and the foil bridges the two retaining means and held in place by the two retaining means.

14. A process according to claim 10 in which the foamable material contains an adhesion promoting material.

15. A process according to claim 10 wherein the foaming takes place in an anticorrosion coating bake oven.
